(19) United States
(12) Patent Application Publication
(10) Pub. No.: US 2012/0307071 A1
(43) Pub. Date: Dec. 6, 2012

(54) MONITORING CAMERA SYSTEM

(76) Inventor: Toshio NISHIDA, Chigasaki (JP)

(21) Appl. No.: 13/479,547

(22) Filed: May 24, 2012

(30) Foreign Application Priority Data
May 30, 2011 (JP) 2011-119876

(51) Int. Cl. H04N 7/18

(52) U.S. Cl. 348/159; 348/E07.085

(57) ABSTRACT

When a camera is intentionally broken and an abnormality occurs in the camera, it is quite important to recognize the state of the camera and the periphery of the camera. In a monitoring camera system including a plurality of cameras and a camera controller to control the cameras, each camera is allocated at a position at which the camera can be photographed by at least one of the other cameras by changing the shooting direction of the one other camera. At occurrence of an abnormality in a camera, each camera conducts a camera control operation based on control processing described in a camera control table held in an internal memory of the camera or the camera controller, to photograph the camera with an abnormality and the periphery of the camera.

### INCORPORATION BY REFERENCE

The present application claims priority from Japanese application JP2011-119876 filed on May 30, 2011, the content of which is hereby incorporated by reference into this application.

### BACKGROUND OF THE INVENTION

The present invention relates to a monitoring camera system including a plurality of cameras.

With recent development of the internet and network cameras, video and audio data is widely transmitted through networks. Specifications of interfaces for network cameras and associated products are standardized by Open Network Video Interface Forum (ONVIF). Interfaces required for the setup, acquisition, streaming, and security of camera information are defined by ONVIF such that cameras can be controlled via networks. As a result, when cameras conforming to ONVIF are coupled via networks with each other, it is possible for the cameras to control communication with each other regardless of producers of the cameras. On the other hand, in the monitoring camera system, it is required to securely shoot an image of a monitor target. When only one camera is employed, the range of areas to be monitored is limited. Hence, in general, the monitoring camera system includes a plurality of cameras. In such situation, it is desirable that the cameras cooperatively conduct photographing or shooting operations. This can be implemented by using cameras conforming to ONVIF. For methods in which cameras cooperatively photograph targets, various techniques have been disclosed.

For example, JP-A-2006-295396 describes a method of improving reliability by providing freedom of designating a master in a monitoring camera system including a plurality of cameras in which an arbitrary one of the cameras is designated as a master and the other cameras are designated as slaves. In a system employing centralized control of a plurality of cameras, images of slave cameras are collected by the master camera to be delivered from the master to hosts (users) in some cases. In such system, when a problem takes place in the master camera, it is not possible to deliver images of slave cameras to the users. To overcome this difficulty, there has been disclosed a method in which one of the slave cameras is designated as a new master to serve the function of the master camera.

JP-A-2003-289532 describes a method for use in a monitoring system including a plurality of cameras in which when an abnormality is detected, a plurality of cameras are controlled to photograph the position of the abnormality in a plurality of directions. When shooting an image of an intruder only in one direction, it may occur that only his or her back view is photographed. To cope with this difficulty, there has been disclosed a method in which a plurality of cameras are employed to photograph the target in a plurality of directions.

### SUMMARY OF THE INVENTION

According to the method of JP-A-2006-295396, at occurrence of a problem in the master camera, one of the slave cameras is designated as a new master to serve the function of the master camera. However, how to recognize the problem in the master camera has not been described. If the camera has been broken by a malicious intruder, it is likely that other cameras are also broken. In such situation, it is important not only to transfer the function of the master camera to the designated camera, but also to clearly recognize the problem in the master camera.

JP-A-2003-289532 describes a method of photographing the position of the abnormality in a plurality of directions by a plurality of cameras. However, description has not been given of an operation in which at occurrence of a problem in a camera, the state of the camera is photographed by other cameras. For this purpose, it is required that the cameras are allocated to places at which the cameras can photograph each other.

It is therefore an object of the present invention that in a monitoring camera system including a plurality of cameras, when an abnormality occurs in a camera and the camera is not able to photograph any target, the camera and its periphery are photographed by other cameras, to thereby clearly recognize the cause of the problem in the camera.

To achieve the object, there is provided a monitoring camera system including a plurality of cameras and a camera controller to control the cameras in which each of the cameras is allocated at a position at which the camera can be photographed by at least one of the other cameras by changing the shooting direction of the one other camera. At occurrence of an abnormality in a camera, each camera conducts a camera control operation based on control processing described in a camera control table held in an internal memory of the camera or the camera controller, to thereby photograph the camera in which an abnormality has occurred and the periphery of the camera.

According to the present invention, when an abnormality occurs in a camera in a monitoring camera system including a plurality of cameras, the camera and the periphery thereof can be recognized by controlling the other cameras. This makes it possible to clearly recognize the cause of the abnormality.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing a monitoring camera system according to a first embodiment of the present invention;

FIG. 2A is a diagram showing an example of shooting directions of monitoring cameras in an ordinary state according to the first embodiment of the present invention;

FIG. 2B is a diagram showing an example of shooting directions of monitoring cameras at occurrence of an abnormality in a camera according to the first embodiment of the present invention;

FIG. 3 is a diagram showing an example of a camera control table according to the first embodiment of the present invention;

FIG. 4 is a flowchart showing an example of a camera control flow according to the first embodiment of the present invention;

FIG. 5 is a diagram showing a monitoring camera system according to a second embodiment of the present invention;

FIG. 6 is a diagram showing an example of a camera control table according to the second embodiment of the present invention; and

FIG. 7 is a flowchart showing an example of a camera control flow according to the second embodiment of the present invention.

### DESCRIPTION OF THE EMBODIMENTS

Referring next to the drawings, description will be given of embodiments according to the present invention. However, the present invention is not restricted by the embodiments.

### First Embodiment

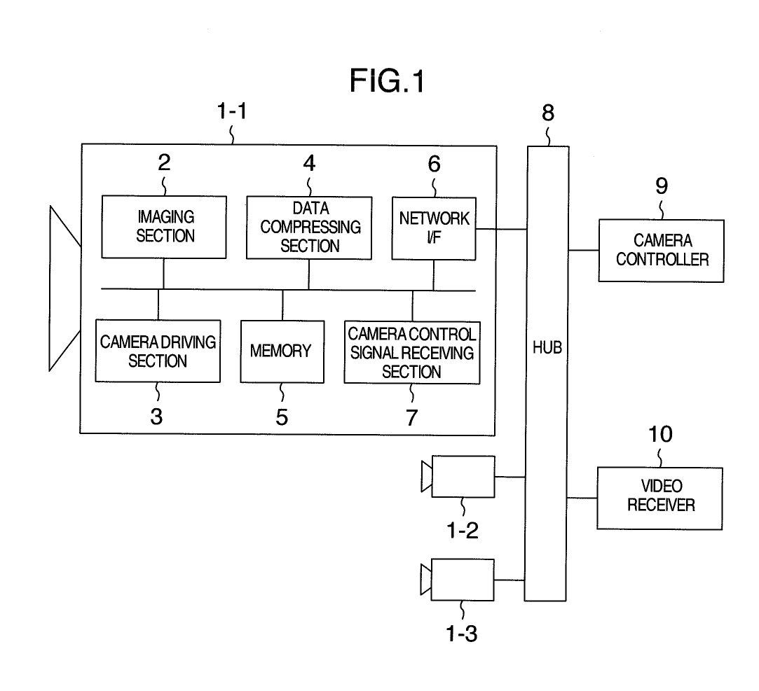

FIG. 1 shows a monitoring camera system according to a first embodiment of the present invention. This example of the monitoring camera system includes three cameras 1-1 to 1-3.

Each of the cameras 1-1 to 1-3 includes an imaging section 2, a camera driving section 3, a data compressing section 4, a memory 5, a network interface (I/F) 6, and a camera control signal receiving section 7.

Video data produced by the imaging section 2 is converted by the data compressing section 4 into compressed data. The data may be compressed in any method. For example, H.264 or MPEG is available. The compressed data is stored in the memory 5. The data in the memory 5 is transferred via the network interface 6 to a network. Video data from each of the cameras 1-1 to 1-3 is fed via a hub 8 to a video receiver 10. Each camera can be controlled by a camera controller 9 via the hub 8. Any one of the cameras 1-1 to 1-3 having received a control signal by its camera control signal receiving section 7 executes desired processing by use of the camera driving section 3.

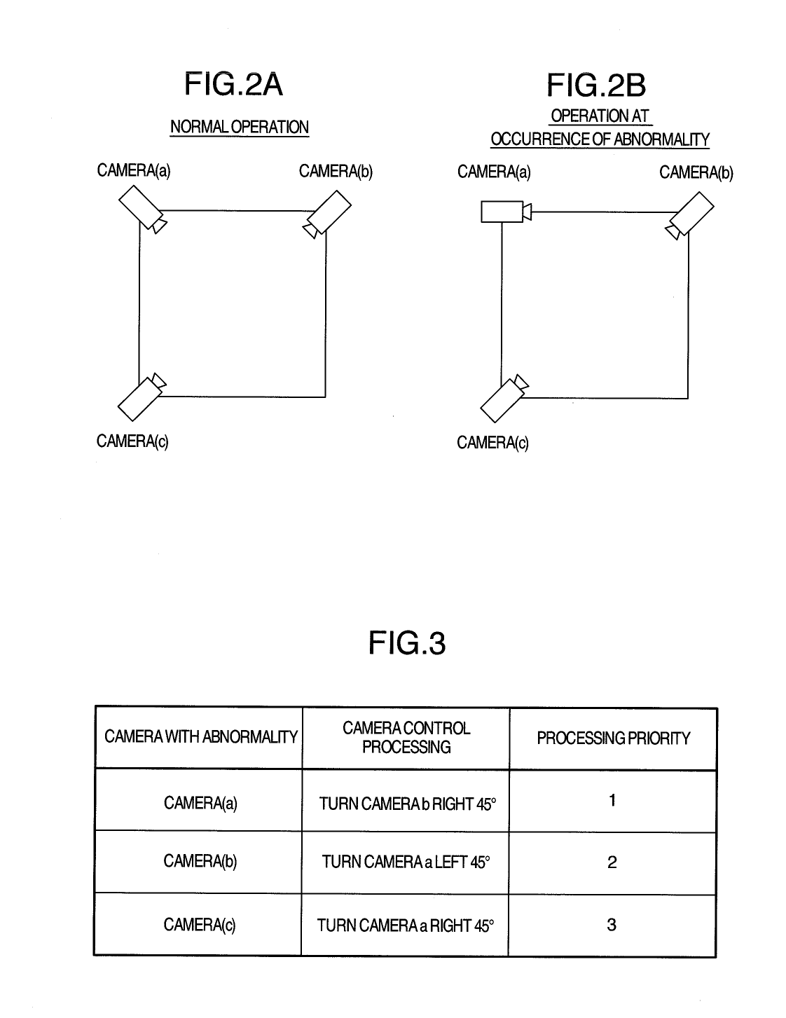

FIGS. 2A and 2B show examples of shooting directions of monitoring cameras according to the first embodiment of the present invention. Specifically, in FIGS. 2A and 2B, monitoring operations using three cameras(A) to (C) each including a turning function are viewed from above. Each camera is installed at a position at which the state of the camera can be photographed by the other cameras by turning these cameras. For example, FIG. 2A shows an ordinary monitoring operation. Camera(B) is installed at a position at which by turning camera(A) to change the shooting direction thereof, it is possible that camera(A) photographs camera(B) and its periphery. Hence, at occurrence of an abnormality in camera b, camera(A) is turned to photograph camera(B) and its periphery as shown in FIG. 2B. For example, when a malicious intruder breaks a camera, the state of the broken camera and the face and the appearance of the intruder can be photographed through the camera control operation described above. The abnormality of the camera may be detected in any method. For example, each camera may include a sensor to detect an abnormality such that at occurrence of an abnormality, the sensor notifies the abnormality to the camera controller 9. Or, interruption of video data to be received by the video receiver 10 may be detected as occurrence of an abnormality.

Description will now be given of a method of controlling each camera at occurrence of an abnormality.

FIG. 3 shows an example of a camera control table according to the first embodiment of the present invention.

The camera controller 9 beforehand stores in its internal memory a table for camera control as shown in FIG. 3. The table includes camera control processing to be conducted at occurrence of an abnormality in a camera. Processing priority is also assigned to the processing in the table. Assume that the camera controller 9 keeps the table of FIG. 3. When an abnormality occurs in camera b, the camera controller 9 sends a control signal to “turn left 45°” to camera(A). In camera a, the camera control signal receiving section 7 receives the control signal and then the camera driving section 3 accordingly executes desired processing. Through the operation, the shooting direction is changed as shown in FIG. 2B. Control of each camera is carried out based on the processing priority described in the table. Assume, for example, that an abnormality occurs in cameras(B) and (C) while using the table shown in FIG. 3. Referring to the table, there are indicated that “turn camera(A) left 45°” at occurrence of an abnormality in camera(B) and “turn camera(A) right 45°” at occurrence of an abnormality in camera c. In both cases, although camera(A) is turned, the turning direction varies between the cases. Hence, the processing is prioritized to avoid any inconsistency in the camera control processing. In the operation associated with the table shown in FIG. 3, the processing priority levels are assigned as “2” to the processing at occurrence of an abnormality in camera(B) and “3” to the processing at occurrence of an abnormality in camera c. In this situation, the system executes the processing of the higher priority, i.e., the processing at occurrence of an abnormality in camera b. In this regard, it is not necessarily required that the cameral control processing is described in the camera control table. Assume, for example, that an abnormality takes place in camera(B) in the monitoring state of FIG. 2A. Camera(C) is originally installed to face camera(B) and is hence capable of photographing the state of camera(B) without any particular camera control. Hence, in such allocation of cameras, it is not necessary for the camera control table to include any description of processing to be executed at occurrence of an abnormality in camera b.

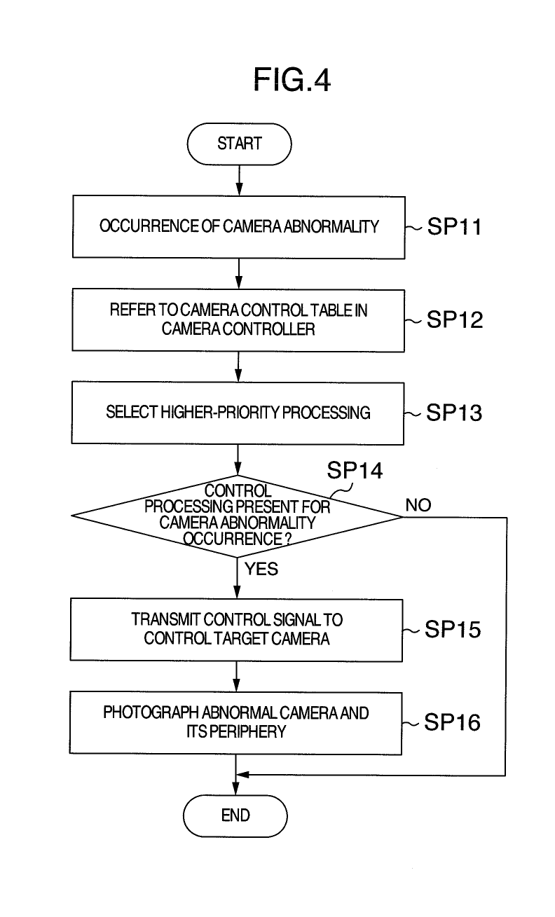

FIG. 4 shows an example of a camera control processing flow according to the first embodiment of the present invention. Description will be given of the processing flow according to the processing sequence.

An abnormality occurs in a camera being used in the monitoring camera system (SP11). The camera controller 9 detects the camera abnormality and refers to the camera control table held in the internal memory (SP12). Based on the priority described in the camera control table, the camera controller 9 selects processing to be executed for the camera in which an abnormality has occurred (SP13). If the camera control processing to be executed at occurrence of an abnormality in the camera is not described in the camera control table (SP14), the system continues the monitoring by use of the current camera control. If the processing is described in the camera control table (SP14), the camera controller 9 sends a control signal to the camera as the control target to execute the camera control processing (SP15). When the control signal is received, the camera carries out associated drive control by the camera driving section 3. The camera turns to face the camera with an abnormality and photographs the camera and the periphery thereof (SP16).

According to the present embodiment, when an abnormality occurs in a camera in a monitoring camera system including a plurality of cameras, each camera is controlled based on the camera control table held in the camera controller, to thereby photograph the camera with an abnormality and the periphery of the camera. Also, by changing the camera control processing and the priority in the camera control table based on the positions and the number of cameras, it is possible to construct a monitoring camera system to flexibly cope with any abnormality in the cameras.

### Second Embodiment

In conjunction with the first embodiment, description has been given of a method in which to recognize the state of the camera with an abnormality, the camera controller controls the other cameras to photograph the state of the camera with an abnormality. For the second embodiment, description will be given of a method in which the abnormality is communicated between the cameras, to photograph the camera with an abnormality without intervention of the camera controller.

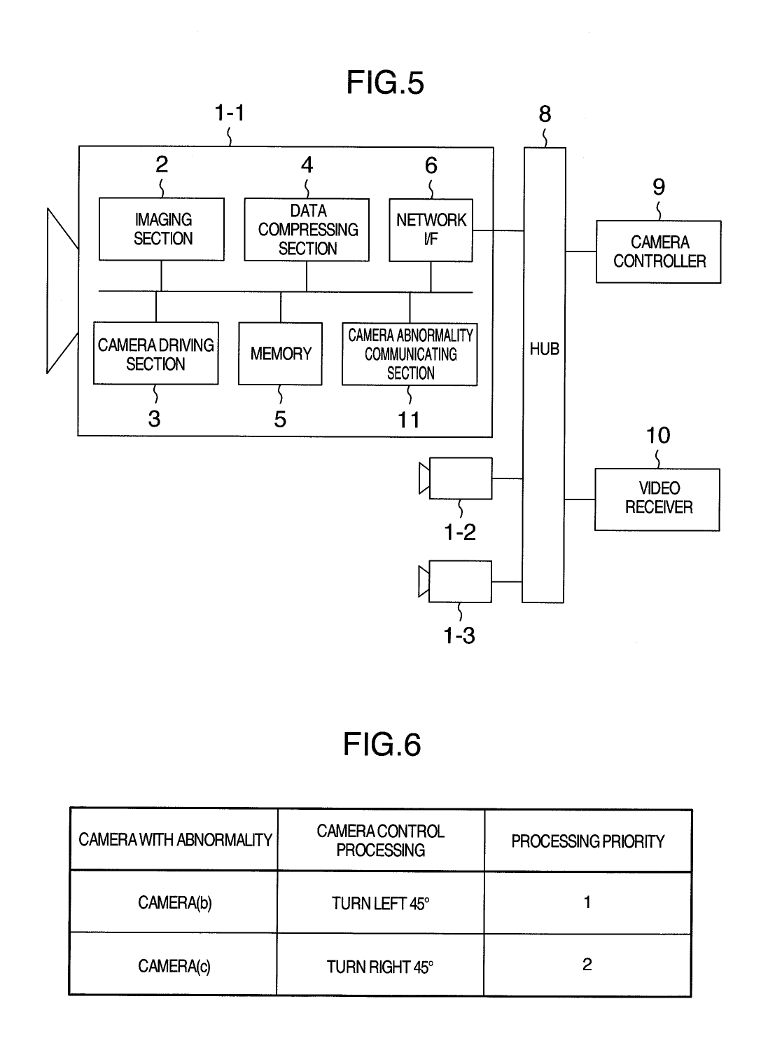

FIG. 5 shows a monitoring camera system according to the second embodiment of the present invention.

In the first embodiment, the monitoring camera system includes the camera control signal receiving section 7 to receive a control signal from the camera controller. In the second embodiment shown in FIG. 5, the monitoring camera system includes a camera abnormality communicating section 11 in place of the camera control signal receiving section 7.

The camera with an abnormality transmits an abnormality signal from the camera abnormality communicating section 11. The camera abnormality is notified via the network interface 6 and the hub 8 to each camera on the network. In any normal camera on the network, the camera abnormality communicating section 11 receives the abnormality signal to recognize occurrence of an abnormality in the camera.

Description will now be given of a method of controlling each camera at occurrence of an abnormality.

FIG. 6 shows an example of the camera control table according to the second embodiment of the present invention.

Each camera beforehand keeps the camera control table shown in FIG. 6 in the internal memory 5. The table indicates camera control processing to be conducted at occurrence of an abnormality in associated cameras. Also, the processing priority is assigned to the camera control processing. The camera control table shown in FIG. 6 is an example of the table held in the internal memory 5 of camera(A) in an operation in which the monitoring is carried out by use of three cameras(A) to (C) each including the turning function as shown in FIGS. 2A and 2B. In the second embodiment, as in the first embodiment, it is assumed that each camera is installed at a position at which the state of the camera can be photographed by the other cameras when they are appropriately turned. Assume in the second embodiment that it is desired to provide camera(A) with a function. Specifically, camera(A) can photograph, at occurrence of an abnormality in any other camera, the camera with an abnormality and the periphery of the camera. For this purpose, control operations of camera(A) at occurrence of an abnormality in camera(B) and camera(C) are described in the camera control table held in the internal memory 5 of camera a. When an abnormality occurs in camera b, camera(A) refers to its own camera control table to select camera control processing for camera b. By referring to the camera control table of FIG. 6, camera(A) obtains an indication of “turn left 45°” and hence conducts the desired drive control operation by the camera driving section 3. Camera(A) turns to face camera(B) and photographs camera(B) and the periphery thereof. As in the first embodiment, the camera control processing is prioritized in the camera control table to avoid any problem in the camera control operation at occurrence of an abnormality in a plurality of cameras. Hence, even when an abnormality takes place in cameras(B) and (C), it is only necessary for camera(A) holding the camera control table shown in FIG. 6 to conduct, based on the priority, the processing for camera(B) with a higher priority level. Also, as in the first embodiment, it is not necessarily required that the cameral control processing is described in the camera control table. Assume, for example, that an abnormality takes place in camera(B) in the monitoring state of FIG. 2A. Camera(C) is originally installed to face camera(B) and is hence capable of photographing the state of camera b. That is, camera(A) is not required to photograph camera b. Hence, in such situation, no problem occurs even if the camera control table does not include the processing to be executed at occurrence of an abnormality in camera b. As above, it is not required for all cameras to photograph the camera with an abnormality. That is, for a camera which is not required to change its photographing direction at occurrence of an abnormality in another camera, processing to be executed at occurrence of the abnormality is not required to be described in the camera control table.

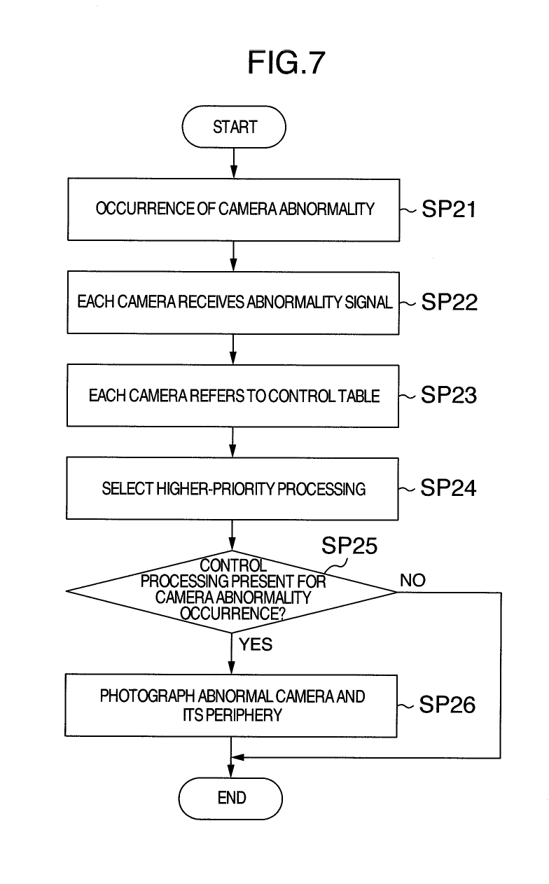

FIG. 7 shows an example of the camera control flow according to the second embodiment of the present invention.

An abnormality occurs in a camera being used in the monitoring camera system (SP21). Each camera on the network receives an abnormality signal sent from the camera with an abnormality (SP22). The camera having received the abnormality signal refers to the camera control table held in its internal memory (SP23). The camera selects processing for the camera with an abnormality based on the priority described in the camera control table (SP24). If the camera control processing to be executed at occurrence of an abnormality in the camera is not described in the camera control table (SP25), the system continues the monitoring based on the current camera control. If the camera control processing is described in the camera control table (SP25), the camera conducts the desired drive control operation by the camera driving section 3 such that the camera turns to face the camera with an abnormality to thereby photograph the camera and the periphery thereof (SP26).

According to the second embodiment, when an abnormality occurs in a camera in a monitoring camera system including a plurality of cameras, each camera controls itself based on the camera control table held in the camera, and it is hence possible to photograph the camera with an abnormality and the periphery thereof. This further makes it possible to recognize the cause of the occurrence of the abnormality. In addition, by changing the camera control processing and the priority in the camera control table according to the positions and the number of cameras, it is possible to implement a monitoring camera system capable of flexibly coping with any abnormality in the cameras. Distinct from the first embodiment, the second embodiment makes it possible to communicate information of the camera abnormality among the cameras to share the camera abnormality information among the cameras. Hence, the monitoring operation can be carried out among the cameras in a cooperative fashion without intervention of the camera controller. As a result, it is also possible to construct the monitoring camera system only using cameras without arranging the camera controller.

When the first and second embodiments are applied to a monitoring camera system, it is required that each camera and the camera controller are provided from one producer. That is, the interface is required to conform to one and the same standard in the communication between the cameras and the camera controller. If each camera and the camera controller are devices conforming to ONVIF, the interface conforms to one and the same standard. Hence, even when these devices are provided from different producers, they may be employed to implement a monitoring camera system according to the embodiments.

As another embodiment, there may be employed a configuration in which the camera control table is disposed on both of the camera side and the camera controller side. In this situation, the camera control signal receiving section 7 of FIG. 1 also includes the function of the camera abnormality communicating section 11 of FIG. 5. In this configuration, even when the abnormality communicating function is disabled on the camera side for some reason, the camera control operation can be carried out on the camera controller side. On the other hand, even when the camera controller is disabled, the advantages of the first and second embodiments are obtainable, which improves reliability of the monitoring camera system.

The present invention is not restricted by the embodiments described above, but various variations are also included. For example, the embodiments have been described in detail for easy understanding of the present invention, but the present invention is not restricted by any embodiment which includes all configurations described above. It is also possible to replace a constituent component of an embodiment by a constituent component of another embodiment. Or, a constituent component of an embodiment may be added to the configuration of another embodiment.

It should be further understood by those skilled in the art that although the foregoing description has been made on embodiments of the invention, the invention is not limited thereto and various changes and modifications may be made without departing from the spirit of the invention and the scope of the appended claims.

1. A monitoring camera system, comprising:
a plurality of cameras; and
a camera controller for controlling the cameras,
wherein each of the cameras comprises a camera driving section for changing a shooting direction of the camera and a camera control signal receiving section for receiving a control signal to the camera driving section;
wherein the camera controller comprises a camera control table including description of processing to be executed by each of the cameras at occurrence of an abnormality in one of the cameras;
wherein each of the cameras is allocated at a position at which the camera can be photographed by at least one of the other cameras by changing a shooting direction of the one other camera; and
wherein at occurrence of an abnormality in one of the cameras, the camera controller sends, based on the camera control table, a control signal to an arbitrary one of the other cameras to change the shooting direction of the arbitrary one camera, to thereby photograph the camera in which the abnormality has occurred and a periphery thereof.

2. A monitoring camera system, comprising:
a plurality of cameras,
wherein each of the cameras comprises a camera driving section for changing a shooting direction of the camera, a camera abnormality communicating section for communicating with the other cameras an abnormality signal notifying an abnormality in one of the cameras, and a camera control table including description of processing to be executed by each of the cameras at occurrence of an abnormality in one of the cameras;
wherein each of the cameras is allocated at a position at which the camera can be photographed by at least one of the other cameras by changing a shooting direction the one other camera; and
wherein each of the cameras changes, at reception of the abnormality signal sent from the camera in which an abnormality has occurred, the shooting direction thereof based on the camera control table, to thereby photograph the camera in which the abnormality has occurred and a periphery thereof.

3. A monitoring camera system, comprising:
a plurality of cameras; and
a camera controller for controlling the cameras,
wherein each of the cameras comprises a camera driving section for changing a shooting direction of the camera, a camera control signal receiving section for receiving a control signal to the camera driving section, a camera abnormality communicating section for communicating, with the other cameras and the camera controller, an abnormality signal notifying an abnormality in one of the cameras; and a camera control table including description of processing to be executed by each of the cameras at occurrence of an abnormality in one of the cameras;
wherein the camera controller comprises a camera control table including description of processing to be executed by each of the cameras at occurrence of an abnormality in one of the cameras;
wherein each of the cameras is allocated at a position at which the camera can be photographed by at least one of the other cameras by changing a shooting direction of the one other camera; and
wherein at occurrence of an abnormality in one of the cameras, a control signal is sent to an arbitrary one of the other cameras based on the camera control table to change the shooting direction of the arbitrary one camera, to thereby photograph the camera in which the abnormality has occurred and a periphery thereof.

4. The monitoring camera system according to claim 1, wherein the camera control table includes priority information of the processing.

5. The monitoring camera system according to claim 4, wherein the processing is selected from the camera control table based on the priority information.
